(19) United States
(12) Patent Application Publication
(10) Pub. No.: US 2015/0261349 A1
(43) Pub. Date: Sep. 17, 2015

(54) TOUCH SENSING METHOD AND TOUCHSCREEN APPARATUS

(71) Applicant: SAMSUNG ELECTRO-MECHANICS CO., LTD., Suwon (KR)

(72) Inventors: Dae Gil YOON, Suwon (KR); Yoon Seok OH, Suwon (KR); Ji Hoon KIM, Suwon (KR)

(73) Assignee: SAMSUNG ELECTRO-MECHANICS CO., LTD., Suwon (KR)

(21) Appl. No.: 14/518,489

(22) Filed: Oct. 20, 2014

(30) Foreign Application Priority Data
Mar. 14, 2014 (KR) 10-2014-0030075

(51) Int. Cl. G06F 3/044

(52) U.S. Cl. CPC G06F 3/044

(57) ABSTRACT

A touch sensing method may include setting at least one touch group according to levels of a plurality of digital data according to changes of capacitance in a plurality of nodes; detecting two nodes having highest levels of the plurality of digital data among the touch group; generating a plurality of combinations by matching nodes defining two vertices, among four vertices of the touch group, facing each other with the two nodes having the highest levels among the plurality of digital data; selecting one combination among the plurality of combinations; and setting an examination region executing a touch separating algorithm according to two points positioned two respective line segments connecting the respective nodes of the selected combination.

### CROSS-REFERENCE TO RELATED APPLICATION

This application claims the benefit of Korean Patent Application No. 10-2014-0030075 filed on Mar. 14, 2014, with the Korean Intellectual Property Office, the disclosure of which is incorporated herein by reference.

### BACKGROUND

The present disclosure relates to a touch sensing method and a touchscreen apparatus.

In general, a touchscreen apparatus such as a touchscreen, a touch pad, or the like, a user interface device attached to a display apparatus to provide an intuitive device interface method to a user, has recently been widely used in various electronic apparatuses such as cellular phones, personal digital assistants (PDAs), navigation apparatuses, and the like. Particularly, as demand for smartphones has recently increased, the use of touchscreens, as touch apparatuses capable of providing various device interface methods in a limited form factor has correspondingly increased.

Touchscreens used in portable apparatuses may mainly be divided into resistive type touchscreens and capacitive type touchscreens, according to a method of sensing a touch implemented therein. Here, capacitive type touchscreens have advantages in that a relatively long lifespan and various interface methods, such as hand gestures may be provided thereby, such that the use thereof has increased. Particularly, capacitive type touchscreens may more easily for allow for multi-touch device interactions, as compared with resistive type touchscreens, such that capacitive type touchscreens are currently widely used in apparatuses such as smartphones, and the like.

Capacitive type touchscreens commonly include a plurality of electrodes having a predetermined pattern and defining a plurality of nodes in which changes in capacitance are generated by a touch. In the plurality of nodes distributed on a two-dimensional plane, changes in self-capacitance or in mutual-capacitance are generated by the touch. Coordinates of the touch may be calculated by applying a weighted average method, or the like, to the changes in capacitance generated in the plurality of nodes.

Recently, the touchscreen apparatus may have multiple touches applied thereto, allowing for increased user convenience and may recognize various types of touch. In this case, various touch separating algorithms for separating the multiple touches recognized as a single touch have been developed. Such touch separating algorithms are generally used for touch data having a level equal to that of a touch reference level or more as the overall examination object. In the case in which all data forming the touch reference level or more are examined, an excessive amount of time may be consumed and a digital processing terminal may be overloaded.

### RELATED ART DOCUMENT

(Patent Document 1) Korean Patent Laid-Open Publication No. 2013-0078462

### SUMMARY

According to an exemplary embodiment in the present disclosure may provide a touch sensing method and a touchscreen apparatus capable of setting a touch group having a quadrangular shape in levels of a plurality of digital data, matching nodes defining two vertices of the touch group facing each other with two nodes having highest levels among digital data among the touch group to generate a plurality of combinations, selecting one combination having a minimum sum of respective distances of corresponding nodes among the plurality of combinations, and then setting an examination region executing a touch separating algorithm.

According to an exemplary embodiment in the present disclosure, a touch sensing method may include: setting at least one touch group according to levels of a plurality of digital data according to changes in capacitance in a plurality of nodes; detecting two nodes having highest levels among digital data among the touch group; matching nodes defining two vertices, among four vertices of the touch group, facing each other with the two nodes having the highest levels among digital data to generate a plurality of combinations; selecting one combination among the plurality of combinations; and setting an examination region executing a touch separating algorithm according to two points positioned two respective line segments connecting the respective corresponding nodes of the selected combination

The touch group may correspond to a quadrangular region surrounding a digital data point having a predetermined reference value or more among the plurality of digital data at the shortest distance.

The touch sensing method may further include comparing the number of nodes of the touch group with a set value of the number of nodes which are preset.

When the number of nodes included in the touch group is larger than the set value of the number of nodes, the two nodes having the highest levels among digital data among the touch group may be detected.

In the selecting of the combination, one combination having a minimum sum of respective distances of corresponding nodes among the plurality of combinations may be selected.

In the detecting of the two nodes, at least two nodes having the highest levels among digital data among nodes spaced apart from each other by a predetermined distance or more may be detected.

In the setting of the examination region, a quadrangular region having the two points positioned on the line segments connecting the respective corresponding nodes of the selected combination as vertices facing each other may be set as the examination region.

The two points may be spaced apart from the two nodes having the highest levels of the digital data point by a preset distance.

The two points may be positioned in centers of the two line segments connecting the respective corresponding nodes of the selected combination.

According to an exemplary embodiment in the present disclosure, a touchscreen apparatus may include: a signal converting unit digitally converting changes in capacitance in a plurality of nodes; and a calculating unit setting a touch group having a quadrangular shape in levels of a plurality of digital data output from the signal converting unit, matching nodes defining two vertices of the touch group facing each other with two nodes having highest levels among digital data among the touch group to generate a plurality of combinations, selecting one combination having a minimum sum of respective distances of corresponding nodes among the plurality of combinations, and then setting an examination region executing a touch separating algorithm.

The touch group may correspond to a quadrangular region surrounding a digital data point having a predetermined reference value or more among the plurality of digital data at the shortest distance.

The calculating unit may determine whether or not the plurality of combinations are generated by comparing the number of nodes of the touch group with a set value of the number of nodes which are preset.

The calculating unit may generate the plurality of combinations when the number of nodes of the touch group is larger than the set value of the number of nodes.

The calculating unit may select one combination having the minimum sum of respective distances of corresponding nodes among the plurality of combinations.

The two nodes having the highest levels among digital data may be two nodes having the highest levels among digital data among nodes spaced apart from each other by a predetermined distance or more.

The examination region may be set according to two points positioned on each of the two line segments connecting the respective corresponding nodes of the selected combination.

The examination region may be a quadrangular region having the two points as vertices facing each other.

The two points may be spaced apart from the two nodes having the highest levels of the digital data point by a preset distance.

The two points may be positioned in centers of the two line segments connecting the respective corresponding nodes of the selected combination.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a perspective view illustrating an exterior of an electronic device including a touchscreen apparatus according to an exemplary embodiment in the present disclosure;

FIG. 2 is a view illustrating a panel unit that may be included in the touchscreen apparatus according to an exemplary embodiment in the present disclosure;

FIG. 3 is a view illustrating a cross-section of the panel unit that may be included in the touchscreen apparatus according to an exemplary embodiment in the present disclosure;

FIG. 4 is a view illustrating a touchscreen apparatus according to an exemplary embodiment in the present disclosure.

FIG. 5 is a flow chart provided in describing a touch sensing method according to an exemplary embodiment in the present disclosure;

FIG. 6 is a view illustrating an example of a digital signal;

FIG. 7 is a view provided for describing a touch group setting method in the digital signal of FIG. 6;

FIG. 8 is a view simply illustrating another example of the digital signal; and

FIGS. 9 and 10 are views for describing an examination region setting method in the digital signal of FIG. 8.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

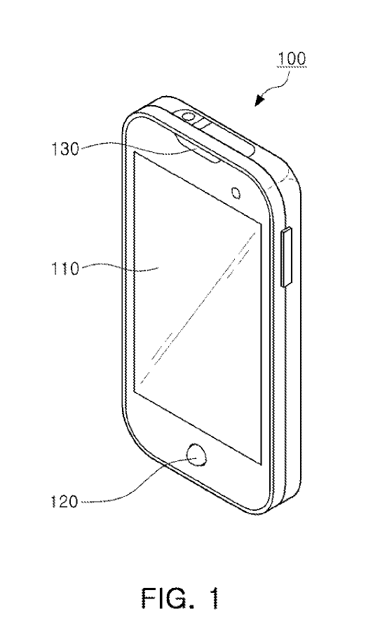

FIG. 1 is a perspective view illustrating an exterior of an electronic device including a touchscreen apparatus according to an exemplary embodiment in the present disclosure.

Referring to FIG. 1, an electronic device 100 according to the present exemplary embodiment may include a display apparatus 110 for outputting a screen, an input unit 120, an audio unit 130 for outputting an audio, and a touch sensing apparatus integrated with the display apparatus 110.

As illustrated in FIG. 1, in the case of a mobile device, the touch sensing apparatus may be generally integrated with the display apparatus and needs to have a high degree of light transmissivity to which an image passes through a screen displayed on the display apparatus. Therefore, the touch sensing apparatus may be implemented by forming an electrode using a transparent and electrically conductive material such as indium tin oxide (ITO), indium zinc oxide (IZO), zinc oxide (ZnO), carbon nano tube (CNT), or graphene on a base substrate formed of a transparent film material such as polyethylene terephtalate (PET), polycarbonate (PC), polyethersulfone (PES), polyimide (PI), a polymethyl methacrylate (PMMA), or the like. In addition, the electrode may be formed of fine conductive lines formed of anyone of silver (Ag), aluminum (Al), chrome (Cr), nickel (Ni), molybdenum (Mo), and copper (Cu), or an alloy thereof.

The display apparatus may include a wiring pattern disposed on a bezel region thereof, wherein the wiring pattern is connected to the electrode. Since the wiring pattern is visually shielded by the bezel region, it may also be formed of a metal material such as silver (Ag), copper (Cu), or the like.

The touchscreen apparatus according to an exemplary embodiment in the present disclosure may be a capacitive type touchscreen apparatus and accordingly, it may include a plurality of electrodes having a predetermined pattern. Also, the touchscreen apparatus according to an embodiment in the present disclosure may include a capacitance detection circuit detecting changes in capacitance generated in the plurality of electrodes, an analog-to-digital conversion circuit converting an output signal from the capacitance detection circuit into a digital value, an operation circuit determining a touch input by using data converted as the digital value, and the like.

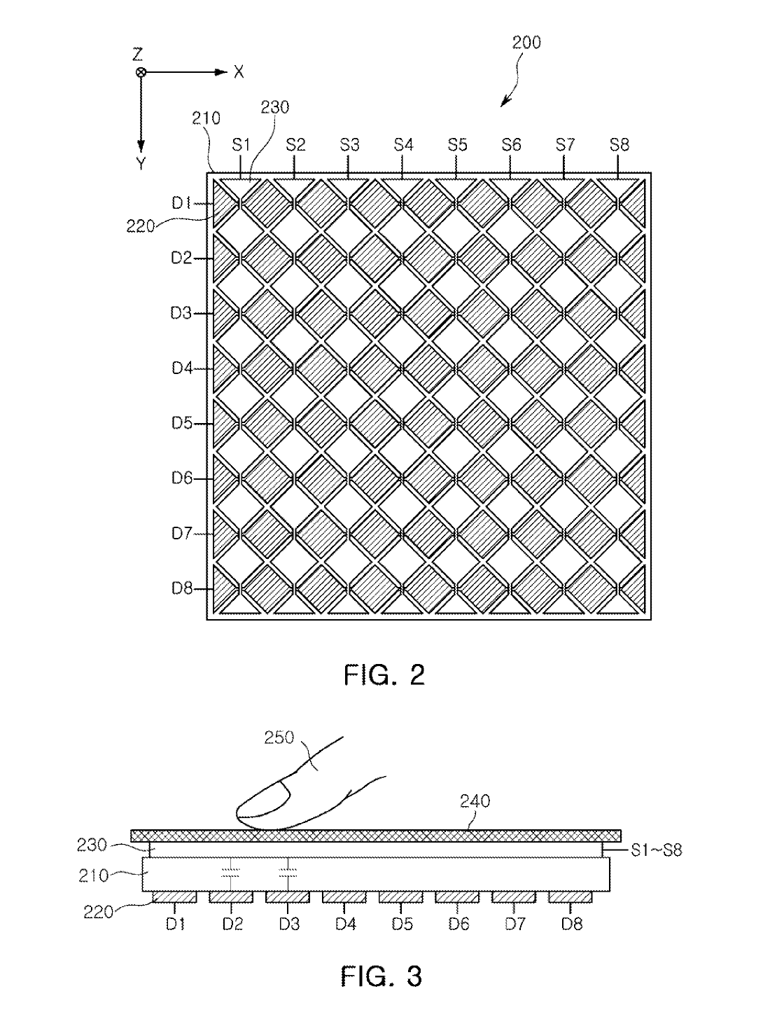

FIG. 2 is a view illustrating a panel unit that may be included in the touchscreen apparatus according to an exemplary embodiment in the present disclosure.

Referring to FIG. 2, the panel unit 200 according to the present exemplary embodiment may include a substrate 210 and a plurality of electrodes 220 and 230 provided on the substrate 210. Although not illustrated in FIG. 2, each of the plurality of electrodes 220 and 230 may be electrically connected to a wiring pattern of a circuit substrate attached to one end of the substrate 210 through wirings and a bonding pad. A controller integrated circuit (a controlling unit) is mounted on the circuit board to detect a sensing signal generated in the plurality of electrodes 220 and 230 and determine a touch input from the sensing signal.

The plurality of electrodes 220 and 230 may be provided on one surface or both surfaces of the substrate 210. Although FIG. 2 shows a case in which the plurality of electrodes 220 and 230 have a rhomboid pattern or a diamond pattern, the plurality electrodes 220 and 230 may also have various polygonal patterns such as rectangular patterns, triangular patterns, or the like in addition to the above-mentioned patterns.

The plurality of electrodes 220 and 230 may include first electrodes 220 extending in an X axis direction and second electrodes 230 extending in a Y axis direction. The first electrodes 220 and the second electrodes 230 may intersect each other on both surfaces of the substrate 210, or on different substrates 210. In the case in which the first electrodes 220 and the second electrodes 230 are all formed on one surface of the substrate 210, predetermined insulating layers may be partially formed in intersections between the first electrodes 220 and the second electrodes 230.

Further, in addition to a region in which the plurality of electrodes 220 and 230 are formed, with respect to a region in which the wirings connected to the plurality of electrodes 220 and 230 are provided, a predetermined printed region for visually shielding the wiring generally formed of an opaque metal material may be formed on the substrate 210.

The apparatus electrically connected to the plurality of electrodes 220 and 230 to sense a touch input may detect changes in capacitance generated in the plurality of electrodes 220 and 230 according to a touch input applied thereto and sense the touch input therefrom. The first electrode 220 may be connected to channels D1 to D8 in the controller integrated circuit to thereby have a predetermined driving signal applied thereto, and the second electrodes 230 may be connected to channels S1 to S8 to thereby be used for the touch sensing apparatus to detect sensing signals. In this case, the controller integrated circuit may detect the change in mutual-capacitance generated between the first electrode 220 and the second electrode 230 as the sensing signals.

FIG. 3 is a view illustrating a cross-section of the panel unit that may be included in the touchscreen apparatus according to an exemplary embodiment in the present disclosure. FIG. 3 is a cross-sectional view of the panel unit 200 of FIG. 2 taken along a Y-Z plane. The panel unit 200 may further include a cover lens 240 to which a touch is applied, in addition to the substrate 210 and the plurality of sensing electrodes 220 and 230 described with reference to FIG. 2. The cover lens 240 may be provided on the second electrode 230 used to detect the sensing signal and receive a touch input applied from a touch object 250 such as a finger, or the like.

When the driving signals are applied to the first electrodes 220 through the channels D1 to D8, mutual capacitance may be generated between the first electrodes 220 to which the driving signals are applied and the second electrodes 230. When the touch object 250 touches the cover lens 240, a capacitance change may be generated in the mutual capacitance generated between the first and second electrodes 220 and 230 that are adjacent to a region touched by the touch object 250. The capacitance change may be in proportion to the touch object 250 and an area of an overlapped region between the first electrodes 220 to which the driving signals are applied and the second electrode 230. In FIG. 3, the mutual capacitance generated between the first and second electrodes 220 and 230 connected to the channels D2 and D3, respectively, may be affected by the touch object 250.

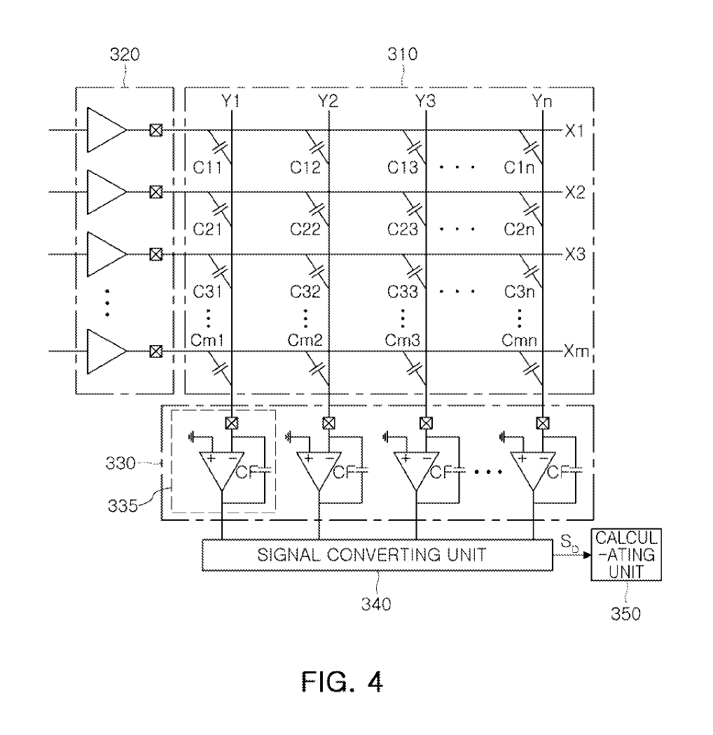

FIG. 4 is a view illustrating a touchscreen apparatus according to an exemplary embodiment in the present disclosure.

Referring to FIG. 4, the touchscreen apparatus according to the present exemplary embodiment may include a panel unit 310, a driving circuit unit 320, a sensing circuit unit 330, a signal converting unit 340, and a calculating unit 350. In this case, the driving circuit unit 320, the sensing circuit unit 330, the signal converting unit 340, and the calculating unit 350 may be implemented in a single integrated circuit (IC).

The panel unit 310 may include a plurality of rows of first electrodes X1 to Xm (driving electrodes) extended in a first axis direction (that is, a horizontal direction of FIG. 4) and a plurality of columns of second electrodes Y1 to Yn (sensing electrodes) extended in a second axis direction (that is, a vertical direction of FIG. 4) intersecting with the first axis. As described above, capacitances may be formed at the intersections of the plurality of first electrodes X1 to Xm and the plurality of second electrodes Y1 to Yn. Node capacitors C11 to Cmn shown in FIG. 4 show capacitances generated at the intersections of the plurality of first electrodes X1 to Xm and the plurality of second electrodes Y1 to Yn as capacitor components.

The driving circuit unit 320 may apply predetermined driving signals to the plurality of first electrodes X1 to Xm of the panel unit 310. The driving signals may be square wave signals, sine wave signals, triangle wave signals, or the like, having a predetermined period and amplitude and be sequentially applied to each of the plurality of first electrodes X1 to Xm. Although FIG. 4 shows a case in which circuits for generating and applying the driving signals are individually connected to each of the plurality of first electrodes X1 to Xm, a configuration in which the driving signal is applied to each of the plurality first electrodes X1 to Xm by including a single driving signal generating circuit and using a switching circuit may also be used. In addition, the touchscreen apparatus may be operated in a scheme in which the driving circuit unit 320 concurrently applies the driving signals to all of the first electrodes or selectively applies the driving signals to only a portion of the first electrodes to simply sense whether the touch input is present or not.

The sensing circuit unit 330 may detect capacitances of the node capacitors C11 to Cmn from the plurality of second electrodes Y1 to Yn. The sensing circuit unit 330 may include a plurality of C-V converters 335 each including at least one operational amplifier and at least one capacitor, wherein each of the plurality of C-V converters 335 may be connected to the plurality of second electrodes Y1 to Yn.

The plurality of C-V converters 335 may convert the capacitances of the node capacitors C11 to Cmn to voltage signals to output analog signals. As an example, each of the plurality of C-V converters 335 may include an integrating circuit integrating the capacitances. The integrating circuit may integrate the capacitances and convert it to a predetermined voltage to output the predetermined voltage.

Although FIG. 4 shows a configuration of the C-V converter 335 in which a capacitor CF is disposed between an inverse terminal and an output terminal of the operational amplifier, an arrangement of the circuit configuration may also be changed. Further, although FIG. 4 shows a case in which the C-V converter 335 includes one operational amplifier and one capacitor, the C-V converter 335 may include a plurality of operational amplifiers and a plurality of capacitors.

In the case in which the driving signals are sequentially applied to the plurality of first electrodes X1 to Xm, since the capacitances may be concurrently detected from the plurality of second electrodes, the number of C-V converters 335 may correspond to the number n of the plurality of second electrodes Y1 to Yn.

The signal converting unit 340 may generate digital signals S_{D} from the analog signals output from the sensing circuit unit 330. As an example, the signal converting unit 340 may include a time-to-digital converter (TDC) circuit measuring a time in which the analog signal output in a voltage form by the sensing circuit unit 330 arrives at a predetermined reference voltage level and converting the measured time into the digital signal S_{D} or an analog-to-digital converter (ADC) circuit measuring an amount by which a level of the analog signal output from the sensing circuit unit 330 is changed for a predetermined time and converting the changed amount into the digital signal S_{D}.

The calculating unit 350 may determine a touch input applied to the panel unit 310 using the digital signals S_{D}. The calculating unit 350 may determine the number, coordinates, gesture operations, or the like, of touch inputs applied to the panel unit 310 using the digital signals S_{D}.

The digital signal S_{D} which is the basis for determining the touch input by the calculating unit 350 may be data digitalizing the changes in capacitance of the node capacitors C11 to Cmn, and particularly, may be data indicating a capacitance difference between a case in which the touch input is not generated and a case in which the touch input is generated. Typically, in the capacitive type touchscreen apparatus, a region in which the conductive object touches has reduced capacitance as compared with a region in which the touch is not generated. Therefore, the region in which the conductive object touches may indicate the capacitance change larger than the region in which the touch is not generated.

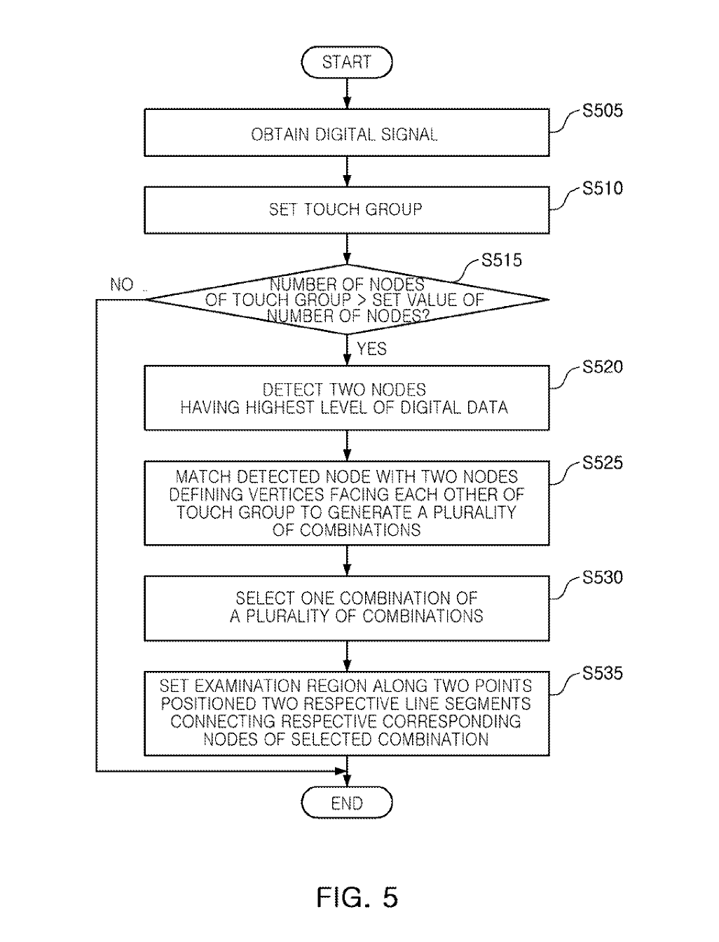

FIG. 5 is a flow chart provided in describing a touch sensing method according to an exemplary embodiment in the present disclosure. Hereinafter, a touch separating method according to the present exemplary embodiment will be described in detail with reference to FIGS. 4 and 5.

Referring to FIG. 5, the touch separating method according to the present exemplary embodiment starts with obtaining, by a calculating unit 350, digital signals S_{D} (S505). In order to obtain the digital signals S_{D}, a driving circuit unit 320 may apply driving signals to a plurality of first electrodes and a sensing circuit unit 330 may detect capacitance from a plurality of second electrodes intersecting with the first electrodes to which the driving signals are applied. The sensing circuit unit 330 may detect a capacitance change in a form of an analog signal using an integrating circuit and the analog signals output by the sensing circuit unit 330 may be converted into the digital signals S_{D} by a signal converting unit 340. A calculating unit 350 may separate touch inputs using the digital signals S_{D} and determine the number, coordinates, gesture operations, or the like, of touch inputs from the separated touch inputs.

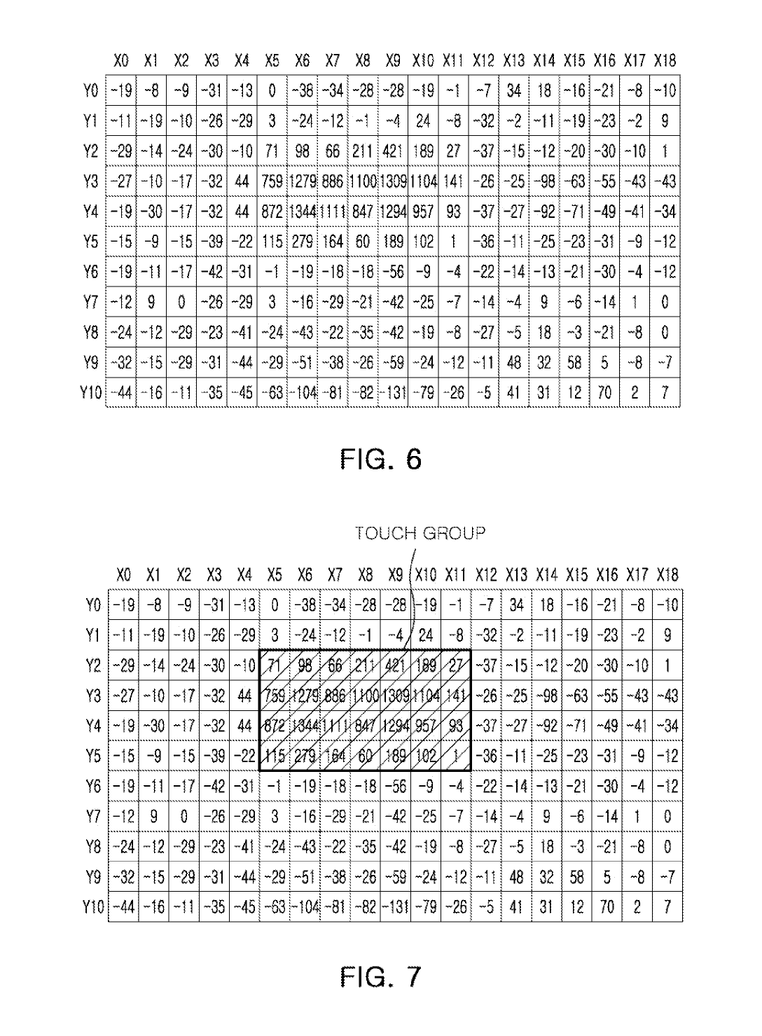

FIG. 6 is a view illustrating an example of a digital signal. When it is assumed that the plurality of first electrodes X1 to Xm and the plurality of second electrodes Y1 to Yn of FIG. 4 are 18 and 10, respectively, the digital signals S_{D} may include a plurality of digital data according to changes in capacitance in the respective nodes with which the plurality of first electrodes X1 to X18 and the plurality of second electrodes Y1 to Y10 are intersected.

Referring to again FIG. 5, the calculating unit 350 may set at least one touch group according to levels of the digital data point (S510). The touch group may refer to a quadrangular region surrounding the digital data point having a reference value or more at the shortest distance, wherein one or a plurality of touch groups may be present according to the levels of the digital data point.

For example, in the case in which the reference value for setting the touch group is set to 100, the digital signals S_{D} of FIG. 6 may have a touch group set as shown in FIG. 7.

The calculating unit 350 may compare the number of nodes of the set touch group with the set value of the number of nodes which are preset (S515). The calculating unit 350 may compare the number of nodes of the touch group with the set value of the number of nodes. Here, in the case in which the set value of the number of nodes is larger than the number of nodes, the calculating unit 350 may determine that the touch group is sufficiently small and terminate the algorithm. However, in the case in which the number of nodes of the touch group is larger than the set value of the number of nodes, the calculating unit 350 may determine that the touch group is large enough to be separated and may perform an operation for setting a region for examining the digital data point, that is, an examination region to separate the touch group.

In this case, the number of nodes of the touch group which is compared by the calculating unit 350 may be at least one of the number of nodes included in the entire touch group and number of nodes defining a shortest distance, a longest distance, a width, and a length of the touch group.

As an example, when it is assumed that the set value of the number of nodes which are preset is 5 and the calculating unit 350 compares the number of nodes corresponding to the longest distance or the width of the touch group with the set value of the number of nodes, the calculating unit 350 may perform an operation (S520) since the number 7 of nodes of the touch group of FIG. 7 is larger than the set value 5 of the number of nodes.

In the case in which the number of nodes of the touch group is larger than the set value of the number of nodes, the calculating unit 350 may detect two nodes having highest levels among digital data among the touch group (S520). In this case, the operation (S520) is an operation to detect nodes corresponding to the respective peak values of two touch inputs when the two touch inputs are applied.

However, when it is assumed that one touch group is divided into two touch groups, that is, first and second touch groups, a maximum level of digital data of the first touch group may be higher than a maximum level of digital data of the second touch group. In this case, since a level of digital data distributed around the digital data point having the maximum level of the first touch group may also be higher than the maximum level of the digital data point of the second touch group, two nodes having highest levels among digital data among nodes spaced apart from each other by a predetermined distance or more may be detected to prevent two digital data from being detected from the first touch group.

In the case in which the two nodes having the highest levels among digital data are detected, the calculating unit 350 may match the detected nodes with nodes defining two vertices, among four vertices of the touch group, facing each other to generate a plurality of combinations (S525). Since two pairs of vertices facing each other are present in the touch group, a total of four combinations may be generated.

Then, the calculating unit 350 may select any one of the plurality of combinations (S530). According to an exemplary embodiment, the selected one combination of the plurality of combinations may be a combination having a minimum sum of the respective distances of the corresponding nodes.

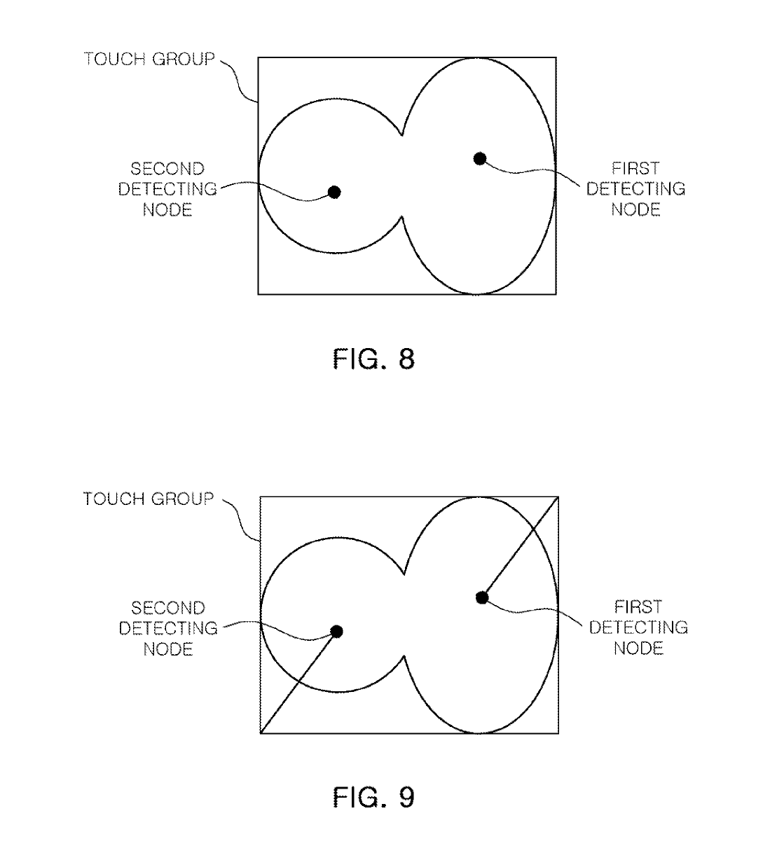

FIG. 8 is a view simply illustrating the digital signal, wherein portions shown in a circular shape are portions corresponding to digital data having a predetermined reference value or more, and first and second detecting nodes represent two nodes having the highest levels among digital data.

In case of FIG. 8, since the first detecting node has a shortest distance from a node of an upper right vertex among nodes of four vertices and the second detecting node has a shortest distance from a node of a lower left vertex among the nodes of the four vertices, the calculating unit 350 may select a combination set by matching the first detecting node with the node of the upper right vertex of the touch group and matching the second detecting node with the node of the lower left vertex of the touch group.

Next, the calculating unit 350 may set an examination region for executing a touch separating algorithm according to two points positioned two respective line segments connecting the respective corresponding nodes of the selected combination (S535). As an example, the examination region may be a quadrangle having the two points positioned on each of the two line segments as the vertices facing each other.

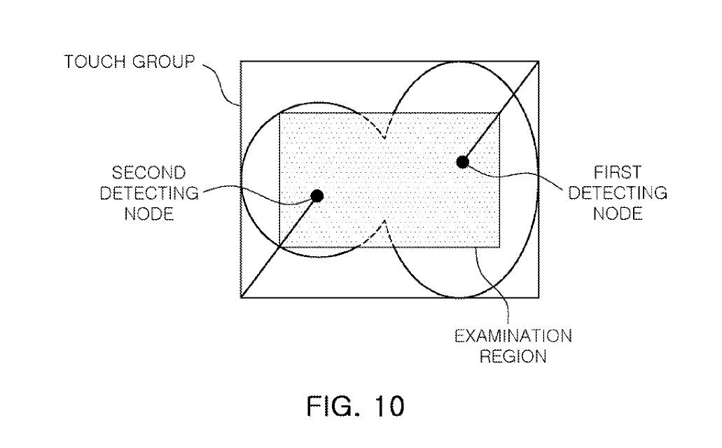

In this case, the two points positioned on each of the two line segments may be spaced apart from the detecting nodes by a preset distance or may be positioned in centers of lengths of two line segments. For example, in the case in which the line segments connecting the corresponding nodes of FIG. 8 to each other are shown as in FIG. 9, the examination region for executing the touch separating algorithm may be set as shown in FIG. 10.

As set forth above, according to exemplary embodiments of the present disclosure, the examination region for performing the touch separating algorithm is set, whereby the time required to perform the touch separating algorithm may be reduced.

While exemplary embodiments have been shown and described above, it will be apparent to those skilled in the art that modifications and variations could be made without departing from the scope of the present invention as defined by the appended claims.

What is claimed is:

1. A touch sensing method comprising:
setting at least one touch group according to levels of a plurality of digital data according to changes of capacitance in a plurality of nodes;
detecting two nodes having highest levels of the plurality of digital data among the touch group;
generating a plurality of combinations by matching nodes defining two vertices, among four vertices of the touch group, facing each other with the two nodes having the highest levels among the plurality of digital data;
selecting one combination among the plurality of combinations; and
setting an examination region executing a touch separating algorithm according to two points positioned two respective line segments connecting the respective nodes of the selected combination.

2. The touch sensing method of claim 1, wherein the touch group corresponds to a quadrangular region surrounding digital data having a predetermined reference value or more among the plurality of digital data at the shortest distance.

3. The touch sensing method of claim 1, further comprising comparing the number of nodes of the touch group with a set value of the number of nodes.

4. The touch sensing method of claim 3, wherein when the number of nodes included in the touch group is larger than the set value of the number of nodes, the two nodes having the highest levels of digital data among the touch group are detected.

5. The touch sensing method of claim 1, wherein in the selecting of the combination, one combination having a minimum sum of respective distances of nodes among the plurality of combinations is selected.

6. The touch sensing method of claim 1, wherein in the detecting of the two nodes, at least two nodes having the highest levels among digital data among nodes spaced apart from each other by a predetermined distance or more are detected.

7. The touch sensing method of claim 1, wherein in the setting of the examination region, a quadrangular region having the two points positioned on the line segments connecting the respective matching nodes of the selected combination as vertices facing each other is set as the examination region.

8. The touch sensing method of claim 1, wherein the two points are spaced apart from the two nodes having the highest levels of the digital data point by a preset distance.

9. The touch sensing method of claim 1, wherein the two points are positioned in centers of the two line segments connecting the respective nodes of the selected combination.

10. A touchscreen apparatus comprising:
a signal converting unit digitally converting changes of capacitance in a plurality of nodes; and
a calculating unit setting a touch group having a quadrangular shape in levels of a plurality of digital data output from the signal converting unit, generating a plurality of combinations by matching nodes defining two vertices of the touch group facing each other with two nodes having highest levels among digital data among the touch group, selecting one combination having a minimum sum of respective distances of nodes among the plurality of combinations, and then setting an examination region executing a touch separating algorithm.

11. The touchscreen apparatus of claim 10, wherein the touch group corresponds to a quadrangular region surrounding digital data having a predetermined reference value or more among the plurality of digital data at the shortest distance.

12. The touchscreen apparatus of claim 10, wherein the calculating unit determines whether or not the plurality of combinations are generated by comparing the number of nodes of the touch group with a set value of the number of nodes which are preset.

13. The touchscreen apparatus of claim 12, wherein the calculating unit generates the plurality of combinations when the number of nodes of the touch group is larger than the set value of the number of nodes.

14. The touchscreen apparatus of claim 10, wherein the calculating unit selects one combination having the minimum sum of the respective. distances of nodes among the plurality of combinations

15. The touchscreen apparatus of claim 10, wherein the two nodes having the highest levels among digital data are two nodes having the highest levels among digital data among nodes spaced apart from each other by a predetermined distance or more.

16. The touchscreen apparatus of claim 10, wherein the examination region is set according to two points positioned on each of the two line segments connecting the respective nodes of the selected combination.

17. The touchscreen apparatus of claim 16, wherein the examination region is a quadrangular region having the two points as vertices facing each other.

18. The touchscreen apparatus of claim 16, wherein the two points are spaced apart from the two nodes having the highest levels among digital data by a preset distance.

19. The touchscreen apparatus of claim 16, wherein the two points are positioned in centers of the two line segments connecting the respective nodes of the selected combination.
